(19) United States
(12) Patent Application Publication
(10) Pub. No.: US 2026/0031066 A1
(43) Pub. Date: Jan. 29, 2026

(54) An Improved Guitar

(71) Applicant: Jacob Taylor Hoffman, Ridgewood, NY (US)

(72) Inventor: Jacob Taylor Hoffman, Ridgewood, NY (US)

(21) Appl. No.: 18/922,073

(22) Filed: Oct. 21, 2024

Related U.S. Application Data
(60) Provisional application No. 63/676,066, filed on Jul. 26, 2024.

(51) Int. Cl. G10D 3/06

(52) U.S. Cl. CPC G10D 3/06

(57) ABSTRACT

A string instrument according to the principles of the invention includes a neck having two playing surfaces. One of the playing surfaces is positioned for easy access by the thumb. The surfaces can be fretted or fretless.

### CROSS-REFERENCE TO RELATED APPLICATIONS

This application claims the benefit of U.S. Provisional Patent Application 63/676,006, filed on Jul. 26, 2024, which application is also incorporated by reference in its entirety and for all purposes.

### FIELD OF THE INVENTION

This invention relates generally to the field of stringed musical instruments, and more particularly to the field of guitars and bass guitars.

### BACKGROUND

Guitars and bass guitars are well-known musical instruments. Typically, a guitar includes the guitar body, a neck extending from the body, and a head or headstock at the end of the neck. The body is the large part of the guitar that amplifies sound, and it includes a bridge for holding guitar strings in place. The strings traverse the length of the neck to the head where each string passes over a nut and is wound around a corresponding tuning peg. The surface of the neck includes a fret board where the player presses the strings against the fretboard to produce different tones. The frets divide the fretboard into semi-tones.

Playing a guitar or indeed any stringed instrument requires finger strength and dexterity. The ability to play notes or combination of notes can be limited by the player's reach and finger mobility. In the design of known guitars, the thumb has limited reach because the player must curl the thumb over the top of the neck to reach the strings. For many players, only the top string is within reach and, depending on the position of the hand, only one or perhaps two frets can be reached without moving the hand up or down the neck.

The shape and construction of guitar necks and the arrangement of strings on guitar necks severely limits the participation of the thumb in playing. Therefore, there is a need for an improved stringed instrument which improves thumb playability.

### SUMMARY

A stringed instrument according to the principles of the invention includes an improved neck. The neck comprises an elongate fingering surface and another elongate planar fingering surface also referred to in this application as a thumb board. In an exemplary embodiment, the thumb board is arranged along the length of the neck from the body to the head stock. The thumb board is angled with respect to the neck surface. A string or strings are arranged along the surface of the thumb board extending from the bridge to the head stock. The angle with respect to the neck and the dimensions of the thumb board are such that the player can more easily reach and create tones on the thumb board strings.

In an illustrative embodiment, the thumb strings connect to additional dedicated nuts, and may include dedicated tuning pegs. If the stringed instrument includes electric amplification, additional pickups can be provided as desired. The thumb board fingering surface can be fretted or fretless. The instrument can be a guitar or a bass guitar or any stringed instrument with a head, neck, and body. The thumb board string or strings can be selected to provide tones as may be desired.

In another illustrative embodiment, the improved guitar neck is made by attaching, such as by glue or other adhesive, a fretted thumb board along an edge of a neck piece having a flat fret board. The top side of the thumb board is substantially perpendicular to the flat fret board surface. A string is attached to the body and to the head such that the string traverses just above the top surface of the thumb board. A player uses the thumb of the fretting hand to apply pressure to the thumb board string.

In another illustrative embodiment, the improved guitar neck is made by including a flattened thumb board on the side of the neck opposite the fret board surface.

It is an unexpected advantage of this arrangement that the player can create compositions playable on a guitar according to the invention that could not be played on a guitar in the prior art.

### BRIEF DESCRIPTION OF THE DRAWINGS

In the drawings:

FIG. 1 shows a prior art guitar;

FIG. 2 shows a guitar according to the principles of the invention;

FIG. 3 shows a cross-sectional view of a guitar neck according to the invention; and

FIG. 4 shows another embodiment of a guitar neck according to the invention.

### DETAILED DESCRIPTION

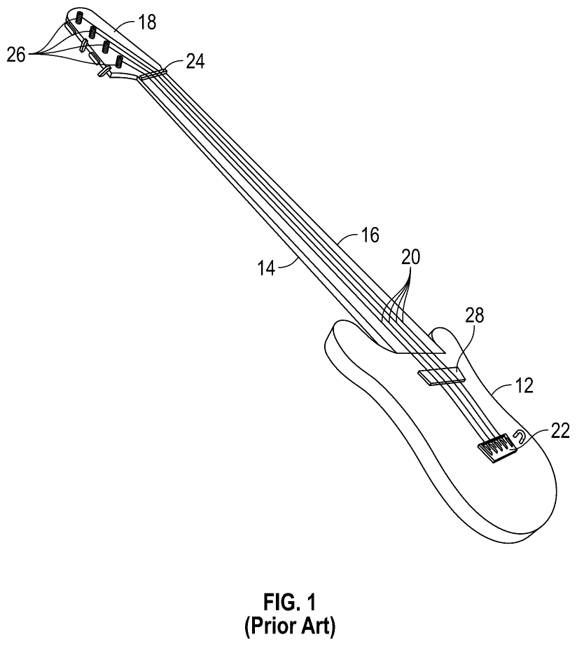

FIG. 1 illustrates a prior art electric bass guitar 10. The guitar 10 includes a body 12, a neck 14, a fret board on the face of the neck 16, and a head stock 18 in known fashion. Strings 20 attached to the body at bridge 22 and to the neck at nuts 24. Tuning pegs 26 permit tensioning the strings by turning the pegs and nuts as is known in the art. Electric pickups 28 located on the body transduce the string vibrations to electric signals. A player using this prior art bass 10 can use his thumb to apply pressure to a string against the fret board by stretching the thumb over the top of the neck to the face of the fret board, as previously explained.

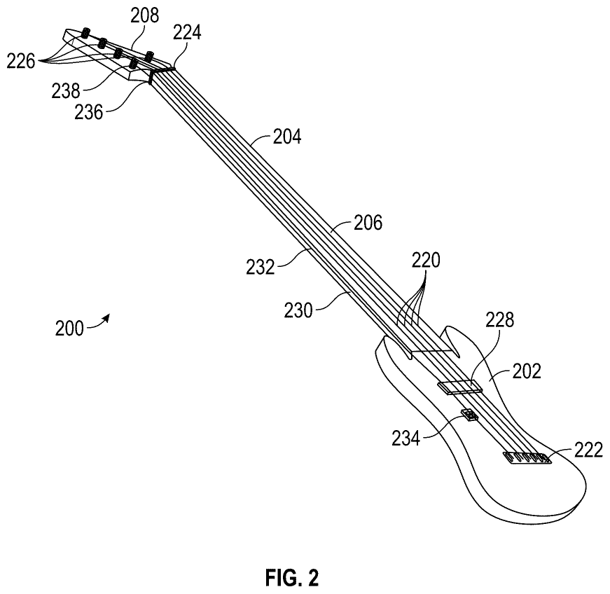

FIG. 2 illustrates a bass guitar 200 according to the principles of the invention. The bass 200 includes a body 202, a neck 204, a fret board 206 on the face of the neck, and a head stock 208. Strings 220 attach to the body at bridge 222 and to the neck at nuts 224. These strings 220 attach to tuning pegs 226 permit tensioning the strings by turning the pegs and nuts as is known in the art. Electric pickups 228 located on the body transduce the string vibrations to electric signals.

Still with respect to FIG. 2, a thumb board 230 extends from the body 202 to the head 208 along the neck at an angle to the fretboard. The thumb board 230 is arranged approximately perpendicular to the neck face. Thumb strings 232 extend from bridge 222 over thumb string pickups 234 located on the body to thumb string nuts 236 on the head. Thumb string tuning pegs 238 are provided to tension the thumb strings.

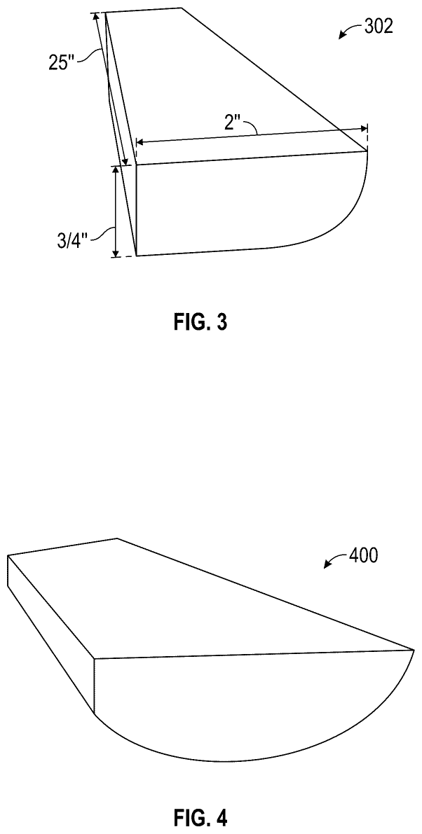

FIG. 3 shows a cross-section 302 of the neck and thumb board combination shown in FIG. 2. While the thumb board extends perpendicular from the top side of the neck, the ordinarily skilled artisan having read this disclosure will understand that the thumb board may extend at any of a range of angle to achieve thumb playability according to the player's requirements.

The illustrated thumb board has a length of approximately 25 inches, and a thickness of 0.75 inches. In this illustrative embodiment, the thickness dimension of 0.75 inches comprises the thumb board playing surface. These dimensions may be varied according to playability requirements, as will be understood by the skilled artisan after reading this disclosure. Likewise, the thumb board need not be a rectangular board with planar sides.

FIG. 4 illustrates in cross-section an exemplary thumb board 400 that has rounded corners. In another embodiment, the thumb board playing surface can range from parallel to the fret board surface to perpendicular to the fret board surface or even angled upward from the fret board surface, as may be desired. Other shapes may be implemented to achieve desirable aesthetic designs, to accommodate less or more strings, to facilitate comfort or to achieve other playability attributes that will be apparent to the person of ordinary skill in the art after reading this disclosure.

The thumb strings 232 can range from a single string to any number of strings that are considered desirable by the player. The thumb strings can be selected to repeat tones already present or to expand the tonal range of the guitar or a combination of repeat and expanded tones. All thumb string arrangements that enhance the playability of the guitar are within the principles of the invention.

A player uses the improved guitar by pressing down upon the string(s) of the thumb board with the thumb, then plucking the section of string above the body. They may treat the rest of the instrument as they would a traditional bass or guitar. When played simultaneously, tones, notes, and intervals can be reached which, previously, would be very strenuous at best and, in many cases, impossible.

There are no special manufacturing requirements for implementing the thumb board according to the invention. It can be made, for example, as a separate piece and attached to the neck, such as by glue or other means apparent to the skilled artisan. In other embodiments, the neck and thumb board can be fashioned from a single piece or multiple components. Other manufacturing processes, such as 3D printing can be used to fashion a neck according to the principles of the invention.

The skilled artisan will understand that the dimensions are merely illustrative and that other dimensions can be implemented without departing from the principles of the invention. Such dimensional alterations are considered within the scope of the invention.

The skilled artisan having read this disclosure will understand that the principles of the invention can be practiced on plucked string instruments other than the illustrated bass guitar, and indeed can be practiced on any such instrument having strings traversing a neck.

The skilled artisan will understand after reading this disclosure that a thumb board and thumb string combination can be implemented at many angles, including directly on the back side of a traditional neck.

The skilled artisan will understand that thumb string pickups, thumb string nuts and thumb string tuning pegs can be mounted on the body and head as may be convenient or aesthetically pleasing without departing from the principles of the invention.

A skilled artisan will understand from reading this disclosure that individual features can be included or excluded while practicing the invention.

It is an unexpected advantage of the enhanced playability of a plucked string instrument according to the invention that compositions can be played that would not otherwise be playable on a prior art guitar. For example, the thumb board and strings according to the invention give rise to the ability to achieve sympathy vibrations when strings are tuned to the same note. Additionally, a stringed instrument according to the invention can include percussion string, in the form of a thumb board string tuned loosely. One may put a string used on a different instrument, for example, adding a high-pitched string to a bass instrument. Separately, there is a case where the thumb board is fretless and the fretboard has frets, or vice versa, thus combining two instruments into one.

All the novel and useful features and combinations of features are enabled by this disclosure are understood to be within the scope of the invention.

I claim:

1. A string instrument comprising:
a body;
a neck extending laterally from the body, the neck having a planar playing surface, a top side and a bottom side;
a head affixed to an end of the neck opposite the body, the head including a plurality of string nuts affixed in threaded operability;
a bridge affixed to the body;
a plurality of strings affixed at an end to the body and traversing the body and neck to the head, each string affixed to a respective nut;
a thumb board extending from the top side of the neck and extending substantially the length of the neck, the thumb board having a fingering surface;
at least one thumb string affixed at one end to the body and traversing the body and thumb board fingering surface to the head; and,
at least one thumb string nut affixed in threaded operability to the head wherein the other end of the at least one thumb string is affixed to the thumb nut.

2. The string instrument of claim 1 further comprising at least another thumb string affixed to the body at one end and to a respective thumb string nut at the head.

3. The string instrument of claim 1 wherein the thumb board comprises frets.

4. The string instrument of claim 1 wherein the stringed instrument is a guitar.

5. The string instrument of claim 1 wherein the stringed instrument is a bass guitar.

6. The string instrument of claim 1 wherein the string instrument is subject to electric amplification, further comprising at least one electric pickup positioned to sense a vibration of the at least one string and at least one thumb string electric pickup positioned to sense a thumb string vibration.

7. The string instrument of claim 1 wherein the thumb board extends substantially perpendicular from the top side of the neck.

8. The string instrument of claim 7 wherein the thumb board fingering surface comprises a length dimension ranging from about 8 inches to about 30 inches.

9. The string instrument of claim 7 wherein thumb board fingering surface comprises a thickness dimension ranging from about 0.5 inches to about 1.25 inches.

10. A string instrument neck comprising a first substantially flat fingering surface and a second substantially flat fingering surface.

11. The string instrument neck of claim 10 wherein the second substantially flat fingering surface is in angled relation to the first substantially flat fingering surface.

12. The string instrument neck of claim 11 wherein the angled relation comprises approximately 90 degrees.

13. A string instrument comprising a neck according to claim 10.

14. An electrified string instrument comprising a neck according to claim 10.

15. A string instrument neck according to claim 10 wherein the first substantially flat fingering surface and the second substantially flat fingering surface comprise frets.

16. The string instrument of claim 1 wherein the at least one thumb string and at least one of the plurality of strings are tuned to the same note.

17. The string instrument of claim 1 wherein the at least one thumb string is a percussion string.

18. The string instrument of claim 5 wherein the at least one thumb string is a high-pitched string.
